(19) United States
(12) Patent Application Publication
(10) Pub. No.: US 2008/0173165 A1
(43) Pub. Date: Jul. 24, 2008

(54) Stringed Musical Instrument with Enhanced Musical Sound

(76) Inventor: Daniel D. DeMars, Norwich, VT (US)

Correspondence Address: DOWNS RACHLIN MARTIN PLLC, 199 MAIN STREET, P O BOX 190, BURLINGTON, VT, 05402-0190, US

(21) Appl. No.: 11/624,714

(22) Filed: Jan. 19, 2007

(51) Int. Cl. G10H 3/18

(52) U.S. Cl. 84/731

(57) ABSTRACT

A stringed musical instrument having an enhanced musical sound, the instrument including one or more capture devices, e.g., a piezo-electric transducer, communicable with at least one structural portion of the musical instrument. The capture devices are configured to detect vibration and convert the vibration to an electrical signal that is transmitted to an amplification device. The amplification device is configured to allow a user to modify the electrical signal for transmission to an external device such as an amplifier and speaker system.

### FIELD OF THE INVENTION

The present invention generally relates to the field of stringed musical instruments having pick-ups for use in connection with the amplification of sound produced by the instruments. In particular, the present invention is directed to a stringed musical instrument having a capture device, e.g., a piezo-electric transducer, that captures mechanical vibration of the instrument and generates an electrical signal in response to the vibration.

### BACKGROUND

To increase the volume of sound produced by stringed musical instruments, e.g., guitars and violins, instrument manufacturers have developed systems for amplifying the sound produced by the instrument. These systems typically utilize electrical components that provide increased audible volume and enhanced sound quality, thereby meeting the needs of most performance environments. These electrical components may capture vibrations emanating from the instrument strings using a magnetic or electromagnetic pick-up placed near the instrument's strings. In the case of acoustic instruments, the air resonating in or from the instrument body may be amplified by the electrical components, e.g., a condenser microphone, placed near the instrument's sound hole or in the body of the instrument.

Although effective at improving the sound volume of the instrument, these existing systems rely on just a subset of the vibrations produced by the instrument, including its strings. Consequently, the known systems often fail to render a rich and complete musical sound because they do not capture other aspects of the vibrational energy produced by the vibrating strings of the musical instrument.

### SUMMARY OF THE DISCLOSURE

In one embodiment, a musical instrument having a plurality of strings is provided. The musical instrument includes a first portion; a second portion located proximate the first portion and in communication with the plurality of strings so that when one or more of the plurality of strings vibrates the second portion is caused to vibrate; and at least one capture device located proximate the second portion so that vibrations present in the second portion are transmitted to the at least one capture device, wherein the capture device generates a first signal that varies as a function of changes in said vibrations transmitted to said at least one capture device.

In another embodiment, a musical instrument having a plurality of strings is provided. The musical instrument including a body portion having a joint portion; a neck portion located proximate the joint portion and in communication with the plurality of strings so that vibrations in one or more of the plurality of strings are transmitted to the neck portion so as to cause the neck portion to vibrate; and a first capture device in communication with the neck portion so that vibrations in the neck portion are transmitted to the first capture device, the first capture device being designed to generate a first signal that changes in response to changes in vibrations in said neck portion.

In still another embodiment, musical instrument is provided. The musical instrument including a body portion having a first recess; a bridge portion disposed on said body portion; a neck portion positioned in said first recess; a first capture device in contact with said neck portion for detecting movement of said neck portion, said first capture device designed to generate a first signal that changes in response to movement of said neck portion; and a second capture device in communication with said bridge portion, said second capture device designed to generate a second signal that changes in response to movement of said bridge portion.

In yet another embodiment, a system for use with a musical instrument having a plurality of strings, a first portion located proximate the plurality of strings so that when one or more of the plurality of strings vibrates the first portion is caused to vibrate, and a cavity positioned proximate the first portion is provided. The system including a piezo-electric transducer that generates a first signal in response to changes in mechanical vibration imparted to the transducer, said transducer being sized and configured for receipt in the first cavity so that when received therein vibrations present in the first portion may be transmitted to said transducer; and at least one amplification device connected to said transducer for amplifying said first signal.

In still yet another embodiment, a method of enhancing the sound of a musical instrument having strings is provided. The method including detecting a mechanical vibration in a portion of a stringed musical instrument other than its strings, the vibration having at least one vibration property; converting the mechanical vibration to an electrical signal having at least one signal property that varies as a function of changes in said at least one vibration property; and amplifying said electrical signal.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a plan view of one embodiment of a stringed musical instrument;

FIG. 2 is a schematic cross-sectional view of the stringed musical instrument of FIG. 2, taken along line 2-2 of FIG. 1, and including an expanded cross-sectional view of a portion of the instrument; and

FIG. 3 is a schematic view of an example of an amplification device that may be used with the stringed musical instrument.

### DETAILED DESCRIPTION

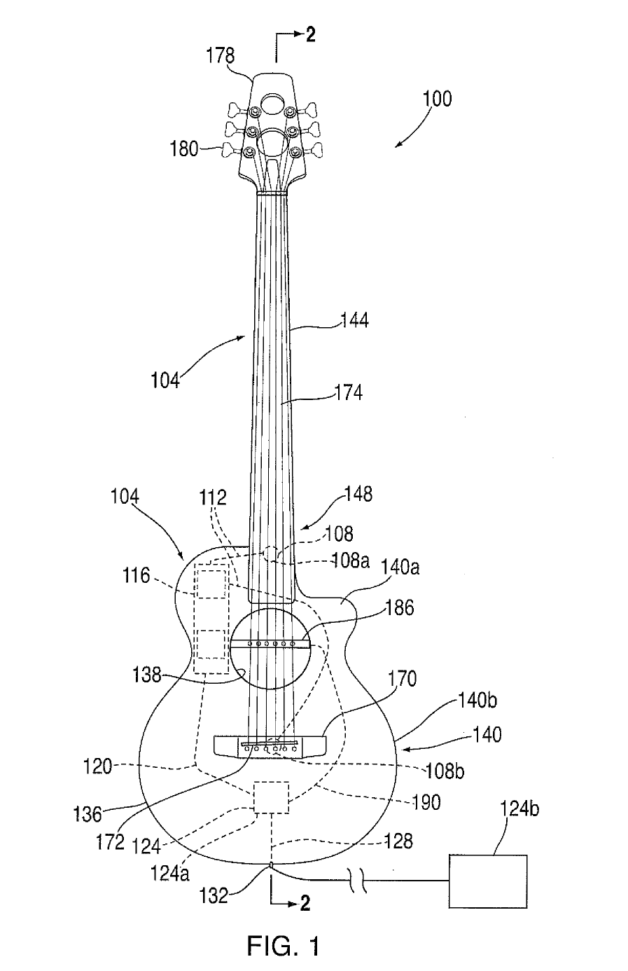

Referring now to the drawings, FIG. 1 illustrates one embodiment of a stringed musical instrument 100. As discussed in more detail below, musical instrument 100 is particularly designed to capture the vibration of a structural portion 104 and to incorporate this vibration into production of the overall sound and tone provided by musical instrument 100, including associated amplification equipment. As elaborated below, a variety of different portions of instrument 100 may function as structural portion 104, hence the use of reference number 104 in FIG. 1 as a general identifier of elements of instrument 100. Musical instrument 100 may include one or more capture devices 108 that may be located proximal to structural portion 104 so as to cause capture devices 108 to react to the mechanical vibrations emitted by structural portion 104 when musical instrument 100 is played. In response to these vibrations, capture devices 108 may generate an electrical signal that is transmitted via line 112 to an amplification device 116, e.g., a pre-amplifier. Amplification device 116 may be designed to receive the signal carried on line 112 and to generate and transmit an amplified signal on line 120 having modified acoustic properties, e.g., bass, treble, midrange, gain and volume. Musical instrument 100 may further include a volume device 124, e.g., a master volume control, that may be configured to receive adjusted signal on line 120 and transmit an output signal via line 128 to output jack 132. Details of various embodiments of instrument 100 are discussed more below.

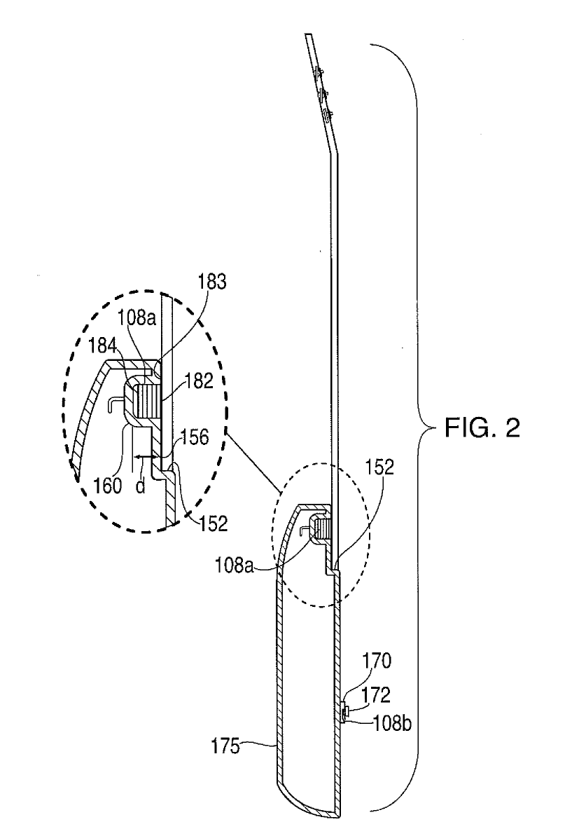

Referring back to FIG. 1, and also to FIG. 2, musical instrument 100 may be virtually any musical instrument, such as, for example and without limitation, an acoustic or electric guitar, an acoustic or electric bass guitar, a mandolin, a violin or other stringed musical instrument. Musical instrument 100 includes a body portion 136. Generally, body portion 136 may be a solid body, e.g., and electric guitar body, or a hollow structure, e.g., an acoustic guitar body or acoustic bass guitar body. In one example, body portion 136 may include a sound hole 138 or other openings (e.g., an f-hole of the type used in violins) that provides access to the interior of body portion 136. Body portion 136 may be constructed from wood, metal, plastic, composites or other materials having properties consistent with musical instrument fabrication. In one example, body portion 136 may be constructed as a single, unitary body. In another example, body portion 136 may be constructed from a series of body pieces 140, such as, for example and without limitation, body top 140a and side wall 140b.

Musical instrument 100 also includes a neck portion 144 disposed on body portion 136. In one example, neck portion 144 and body portion 136 may be formed as a unitary structure. In another example, neck portion 144 maybe fastened to body portion 136 at joint portion 148 using a variety of fasteners, adhesives or other alternative securing methods commonly known in the art. Joint portion 148 may be a joint such as, for example, a mortise and tenon joint, dovetail joint or Spanish heel joint, that joins neck portion 144 to body portion 136. The structure of these joints is readily appreciated in the art so no additional explanation or description is provided.

Body portion 136 may include a first recess 152 (FIG. 2) having a first surface 156. First recess 152 is sized and configured to receive neck portion 144, as illustrated in FIG. 2. When positioned in first recess 152, neck portion 144 typically, although not necessarily, contacts first surface 156. Those skilled in the art will readily appreciate the fastening means, e.g., fasteners and/or adhesives, that may be used to secure neck portion 144 to body portion 136 within first recess 152.

Instrument 100 may also include a second recess 160. In one embodiment, second recess 160 may be formed in body portion 136, although it may be desirable to place the second recess in other portions of instrument 100. For some embodiments of instrument 100, it may be desirable to position second recess 160 in first recess 152 so that it opens outwardly to first surface 156, as shown in FIG. 2. Second recess 156 has a depth d, as measured between the base of the second recess and surface 156. Second recess 156 also has a cross-sectional configuration that corresponds to the cross-section configuration of capture device 108 so as to allow the capture device to be positioned in the second recess, as discussed more below.

Musical instrument may also include a bridge portion 170 having a saddle 172. For guitars and certain other instruments, bridge portion 170 may be secured to body portion 136, e.g., body top 140a, using fasteners or adhesives, as described previously. Bridge portion 170, alternatively, may be incorporated into the structure of body portion 136, or may be secured in a manner so as to cause part of bridge portion 170 to be recessed into body top 140a. For other types of musical instruments, e.g., a violin, bridge portion 170 is held against body top 140a merely by the downward pressure of plurality of strings 174.

Discussing strings 174, and their attachment to instrument 100, in more detail, the strings may be metal, plastic, gut, composites, combinations of the above, and any other material commonly recognized in the art. In one example, the proximal end of strings 174 may be attached directly to bridge portion 170. In another example, the proximal ends of strings 174 may extend through openings (not shown) in bridge portion 170, through body portion 136 and then are secured to the back side 175 (FIG. 2) of instrument 100 (not shown). In yet another example, the proximal ends of strings 174 may be attached to a tailpiece (not shown) that is attached to body portion 136. Strings 174 traverse neck portion 140, as illustrated in FIG. 1.

Musical instrument 100 may include a headstock portion 178 for use in securing the distal ends of strings 174 to the instrument. Headstock portion 178 may be secured to, or integral with, neck portion 144. The distal ends of strings 174 may be secured to headstock via tuners 180. In another example, such as a violin, a scroll or other structure having tuning pegs (not shown) may be used in place headstock portion 178. The distal ends of the strings are attached to the tuning pegs. The number of strings 174 used in instrument 100 will vary according to the type, design and acoustic requirements of musical instrument 100, such as, for example, acoustic and acoustic bass guitars having four, five, six, ten or twelve strings.

As mentioned briefly above, musical instrument 100 also includes one or more capture devices 108, e.g., 108a, 108b. Capture devices 108 may have a capture surface 182 (FIG. 2). Each of capture devices 108 is designed to respond to movement, e.g., a mechanical vibration, transmitted thereto, typically via capture surface 182. In response to such vibration, capture devices 108 generate an electrical signal having signal properties that vary in response to changes in characteristics of the vibration transmitted thereto. In one example, capture devices 108 may be piezo-electric devices, such as, for example, disc-style, ribbon-style or stick-style piezo-electric transducers.

Capture devices 108 may be positioned in a wide variety of locations in instrument 100, although some locations will produce better results than others. In any event, capture devices 108 should be positioned so that they are proximate a portion of instrument 100 that vibrates as a result of strings 174 being caused to vibrate, e.g., by plucking or bowing. In some cases it may be desired to position a capture device 108 so that capture surface 182 directly contacts the vibrating portion of instrument 100, while in other cases other structure may be positioned between the vibrating portion and the capture device.

As discussed above, capture devices 108 may be positioned in second recess 160. In one example, as illustrated in FIG. 2, second recess 160 is positioned in first recess 152, which is positioned at one end of body portion 136. Second recess 160 is exaggerated as shown in the drawing for clarity. With this placement, second recess 160 opens out to first surface 156, and hence out to neck portion 144 when positioned in first recess 152. It is to be appreciated, however, that second recess 160 may be positioned in other locations in body portion 136, and in neck 144, including its headstock 178. Further, capture devices 108 need not necessarily be positioned in second recess 160 or any recess.

With continuing reference to the embodiment of the invention illustrated in FIG. 2, second recess 160 may be sized and positioned in first recess 152 such that when capture device 108a is positioned in the second recess its capture surface 182 directly contacts an inner surface 183 (FIG. 2) of neck portion 144. Depth d of second recess 160 may be selected so that it substantially equals the thickness of capture device 108, with the result that capture surface 182 is located in substantially coplanar relationship with first surface 156, as illustrated in FIG. 2. In another example, depth d may be deeper than capture device 108 is thick, and then this depth may be decreased using a spacer 184 positioned beneath the capture device so that capture surface 182 is positioned to receive vibrations present in neck portion 144. While capture device 108 is illustrated as directly contacting surface 183 of neck portion 144, it is to be appreciated that in other embodiments it may be desirable to position structure of various types, e.g., films, adhesives, spacers and the like, between capture surface 182 and surface 183 of neck portion 144. Such intervening structure should not, however, completely dampen vibrations present in neck portion 144 so that they do not reach capture device 108. Those skilled in the art will understand the various connection means, e.g., fasteners and/or adhesives, that may be used to secure capture devices 108 to second recess 160.

As indicated above, capture devices 108 may be positioned on or in musical instrument 100 in locations other than in first recess 152. In one example, capture device 108b may be positioned inside body portion 136, beneath bridge 170, or beneath bridge saddle 172 as illustrated in FIGS. 1 and 2. Again, capture device 108b is positioned so that mechanical vibration imparted from strings 174 to bridge 170 is transmitted to the capture device 108b.

Musical instrument 100 may also include an amplification device 116. Amplification device 116 may be connected to capture devices 108, e.g., 108a, 108b via line 112. Amplification device 116 may be designed to amplify the electrical signal generated by capture device 108a and transmitted via line 112, and to generate an adjusted signal. Amplification device 116 may be a portably attached device, such as for example, a pre-amplifier device carried by the user (not shown). Alternatively, amplification device 116 may be disposed in body portion 136. In one example, amplification device 116 may be a pre-amplifier device, e.g., the PowerBlend™ dual-channel 9-volt pre-amplifier sold by K&K Sound Systems, Inc. of Coos Bay, Oreg.

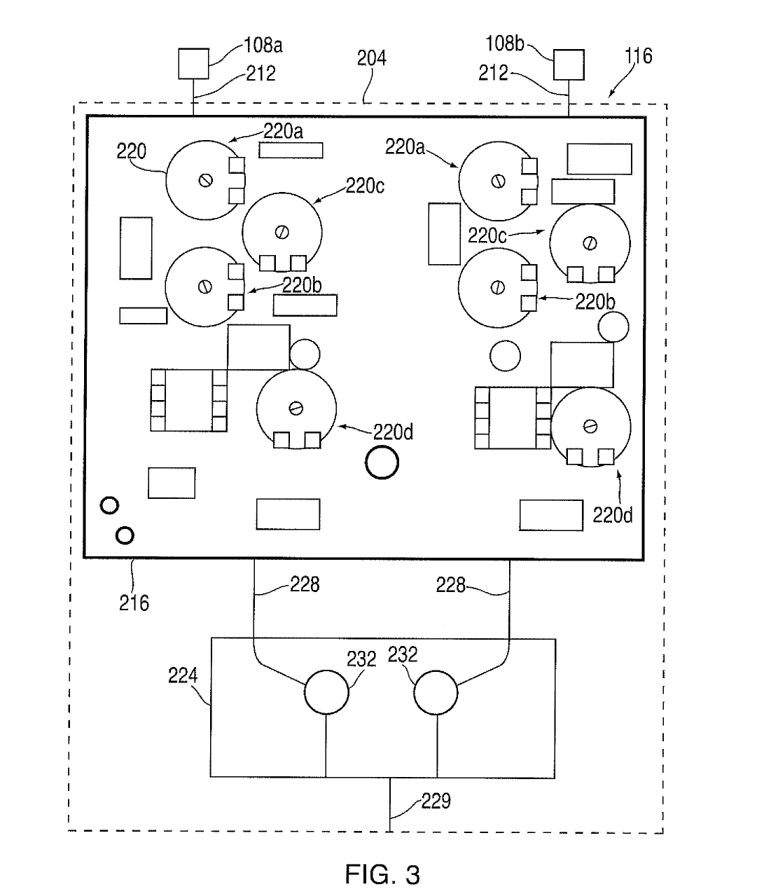

Details of one embodiment of amplification device 116 are illustrated in FIG. 3 and described below. Referring to FIGS. 1 and 3, amplification device 116 may include a pre-amplifier 204 that may be connected to on-e or more capture devices 108 (FIG. 1). Pre-amplifier 204 is designed to amplify and modify the signal provided by capture devices 108 via line 212. Pre-amplifier 204 may include a primary device 216. Primary device 216 is designed to modify the signal provided from capture devices 108, e.g., boost the bass portion of the signal. In one example, primary device 216 may include one or more potentiometers 220 for modifying specific properties of the signal provided by capture devices 108. More particularly, potentiometers 220 may provide for the adjustment of various signal properties, such as, for example, bass (e.g., 220a), treble (e.g., 220b), mid-range (e.g., 220c), gain (e.g., 220d) or other signal properties appreciated by those ordinarily skilled in the art.

Amplification device 200 may also include a secondary device 224 that communicates with primary device 216 via lines 228. Secondary device 224 amplifies the modified signal received via line 228. Secondary device 224 generates an amplified signal that is provided as an output via line 229. In one example, secondary device 224 may include one or more thumbwheels 232 or other adjustment devices, as desired. Thumbwheels 232 may provide for the adjustment of various signal properties, such as, for example, volume, as appreciated by those ordinarily skilled in the art.

Musical instrument 100 may also include a volume device 124. Volume device 124 may be connected to amplification device 116 via line 120. Volume device 124 is designed to amplify the adjusted signal generated by amplification device 116, and as discussed below, the signal generated by pick-up device 186. In one example, volume device 124 may be a volume control device, e.g., a master volume control or other similar control device readily appreciated in the art. Volume device 124 may be located in body portion 136, e.g., device 124a, with its output signal being transmitted to output jack 132 via line 128. In another example, volume device 124 may be located external of musical instrument 100, e.g., device 124b.

Referring back to FIGS. 1 and 2, musical instrument 100 may also include a conventional magnetic pick-up device 186. Pick-up device 186 may be a magnetic or electro-magnetic pick-up device that is designed to detect movement of strings 174, i.e., mechanical vibration of the strings that is induced by plucking or bowing the strings. Like capture device 108, although using different principles of operation, pick-up device 186 generates an output signal that varies in response to changes in the movement of strings 174. Pick-up device 186 may be positioned beneath strings 174 aid proximate enough that movement of the strings changes the magnetic flux generated by the pick-up device, thereby inducing an electrical voltage in the coils of the pickup device. The output of pick-up device 186 may be provided via line 190 to volume device 124 or alternatively to amplification device 116. In one example, pick-up device 186 may be positioned near sound hole 138. When pick-up device 186 is used with instrument 100, strings 174 should be made at least partially of metal.

As used in the claims, the “first portion” of musical instrument 100 may include any portion of the instrument, including body portion 136. The “second portion” of instrument 100, as used in the claims, is typically the portion of the instrument that generates the vibration that is transmitted, directly or indirectly, to capture devices 108, such as, for example, neck portion 144, bridge portion 170 or even headstock portion 178. In some cases, the first portion and second portion of instrument 100 will be different portions of the instrument, while in other cases the first portion and second portion will be different sections of the same portion of the instrument. In yet other cases, the first and second portions could be the same section of the same portion of instrument 100.

In operation, a user of instrument 100 may cause one or more of the plurality of strings 174 to vibrate, e.g., by plucking or bowing. This vibration may be transmitted to one or more of structural portions 104 so as to cause a mechanical vibration in structural portion 104, e.g., neck portion 144. A capture device 108 placed proximate structural portion 104 responds to the mechanical vibration. In one example, the mechanical vibration may be transmitted via the interface between capture surface 182 and surface 183 of neck portion 144. Capture device 108 generates an electrical signal that varies as a function of the mechanical vibration transmitted to it from structural portion 104.

This electrical signal is received by amplification device 116 through line 112. In some cases, this signal may be adjusted, e.g., by a user manipulating potentiometers 220 (FIG. 2), to generate an amplified signal that has signal properties, such as bass, treble, mid-range and gain, preferred by the user. The amplified signal may then be transmitted, via line 120, to a volume device 124, where a user may further amplify the amplified signal by adjusting additional signal properties, e.g., volume, as desired. Volume device 124 generates an output signal that is transmitted to output jack 132 for transmission to an external device 124b, such as, an amplifier, soundboard or P.A. system.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A musical instrument having a plurality of strings, comprising:
(a) a first portion;
(b) a second portion located proximate said first portion and in communication with the plurality of strings so that when one or more of the plurality of strings vibrates said second portion is caused to vibrate; and
(c) at least one capture device located proximate said second portion so that vibrations present in said second portion are transmitted to said at least one capture device, wherein said capture device generates a first signal that varies as a function of changes in said vibrations transmitted to said at least one capture device.

2. The musical instrument according to claim 1, further comprising at least one amplification device connectable to said at least one capture device for amplifying said first signal so as to produce a second amplified signal.

3. The musical instrument according to claim 2, wherein said at least one amplification device includes a pre-amplifier device.

4. The musical instrument according to claim 2, wherein said at least one amplification device includes a dual-channel 9-volt pre-amplifier.

5. The musical instrument according to claim 2, further comprising a volume device connectable to said at least one amplification device for further amplifying said second amplified signal.

6. The musical instrument according to claim 5, further comprising at least one magnetic pick-up device located proximate said plurality of strings, wherein said magnetic pick-up device generates a pick-up signal that changes in response to changes in vibration of the plurality of strings.

7. The musical instrument according to claim 1, wherein said at least one capture device is a piezo-electric transducer.

8. The musical instrument according to claim 1, wherein said second portion includes a neck portion.

9. The musical instrument according to claim 8, wherein said second portion includes a bridge portion.

10. A musical instrument having a plurality of strings, comprising:
(a) a body portion having a joint portion;
(b) a neck portion located proximate said joint portion and in communication with said plurality of strings so that vibrations in one or more of the plurality of strings are transmitted to said neck portion so as to cause said neck portion to vibrate; and
(c) a first capture device in communication with said neck portion so that vibrations in said neck portion are transmitted to said first capture device, said first capture device being designed to generate a first signal that changes in response to changes in vibrations in said neck portion.

11. The musical instrument according to claim 10, further comprising at least one amplification device connected to said first capture device for amplifying said first signal.

12. The musical instrument of claim 10, wherein said first capture device is a piezo-electric transducer.

13. The musical instrument of claim 10, wherein said first capture device is located between said body portion and said neck portion.

14. The musical instrument of claim 10, wherein said joint portion includes a first recess for receiving said neck portion and a second recess for receiving said first capture device.

15. The musical instrument of claim 10, further comprising a bridge portion positioned on said body portion and a second capture device in communication with said bridge portion, said second capture device being configured to generate a second signal that changes in response to changes in vibrations in said bridge portion, wherein said at least one amplification device is connected to said second capture device.

16. The musical instrument of claim 15, wherein said second capture device is a piezo-electric transducer.

17. A musical instrument, comprising:
(a) a body portion having a first recess;
(b) a bridge portion disposed on said body portion;
(c) a neck portion positioned in said first recess;
(d) a first capture device in contact with said neck portion for detecting movement of said neck portion, said first capture device designed to generate a first signal that changes in response to movement of said neck portion; and
(e) a second capture device in communication with said bridge portion, said second capture device designed to generate a second signal that changes in response to movement of said bridge portion.

18. The musical instrument according to claim 17, further comprising at least one amplification device connected to said first and second capture devices for amplifying said first and second signals.

19. The musical instrument according to claim 18, wherein said at least one amplification device includes a pre-amplifier device for amplifying said first and second signals.

20. The musical instrument according to claim 18, wherein said at least one amplification device includes a volume device for further amplifying said first and second signals following amplification by said pre-amplifier device.

21. The musical instrument of claim 17, wherein said first capture device is positioned between said neck portion and said body portion.

22. The musical instrument of claim 17, wherein said first recess includes a second recess and said first capture device is positioned in said second recess.

23. The musical instrument of claim 20, further comprising a magnetic pick-up device positioned proximate the plurality of strings and configured to generate a pick-up signal that varies as a function of changes in vibration of the plurality of strings, wherein said pick-up device is connected to said volume device so that said pick-up signal is provided to said volume device for amplification.

24. A system for use with a musical instrument having a plurality of strings, a first portion located proximate the plurality of strings so that when one or more of the plurality of strings vibrates the first portion is caused to vibrate, and a cavity positioned proximate the first portion, the system comprising:
(a) a piezo-electric transducer that generates a first signal in response to changes in mechanical vibration imparted to the transducer, said transducer being sized and configured for receipt in the first cavity so that when received therein vibrations present in the first portion may be transmitted to said transducer; and
(b) at least one amplification device connected to said transducer for amplifying said first signal.

25. The system according to claim 24, further comprising at least one magnetic pick-up device locatable proximate said plurality of strings, wherein said pick-up device generates a pick-up signal that changes in response to movement of said plurality of strings.

26. A method of enhancing the sound of a musical instrument having strings, comprising:
(a) detecting a mechanical vibration in a portion of a stringed musical instrument other than its strings, the vibration having at least one vibration property;
(b) converting the mechanical vibration to an electrical signal having at least one signal property that varies as a function of changes in said at least one vibration property; and
(c) amplifying said electrical signal.
